(19) United States
(12) Patent Application Publication
(10) Pub. No.: US 2022/0099534 A1
(43) Pub. Date: Mar. 31, 2022

(54) POPULATING A TEST CASE SET BASED ON WEATHER INFORMATION

(71) Applicant: International Business Machines Corporation, Armonk, NY (US)

(72) Inventors: Lisa Seacat DeLuca, Baltimore, MD (US); Schuyler Bruce Matthews, Cary, NC (US)

(21) Appl. No.: 17/035,840

(22) Filed: Sep. 29, 2020

(51) Int. Cl. G01M 99/00; G06F 16/953

(52) U.S. Cl. CPC G01M 99/005; G01W 1/10; G06F 16/953

(57) ABSTRACT

Aspects of the present invention disclose a method, computer program product, and system for generating test case requirements for testing an asset at a location using actual upcoming weather information. The method includes one or more processors receiving a set of usage parameters for an asset. The method further includes one or more processors a location from the received set of usage parameters. The method further includes one or more processors determining weather information that is associated with the identified location. The method further includes one or more processors generating a test case for the asset that includes one or more testing variables that test data in the determined weather information that is associated with the identified location.

### BACKGROUND OF THE INVENTION

The present invention relates generally to the field of data management, and more particularly to test cases for product testing.

Product lifecycle management (PLM) is the process of managing the entire lifecycle of a product from inception, through engineering design and manufacture, to service and disposal of manufactured products. PLM integrates people, data, processes and business systems and provides a product information backbone for companies and their extended enterprise. An important aspect of PLM is product testing and quality control, throughout the development of a product. In engineering, a test case is a specification of the inputs, execution conditions, testing procedure, and expected results that define a single test to be executed to achieve a particular testing objective.

Weather forecasting is the application of science and technology to predict the conditions of the atmosphere for a given location and time. Weather forecasts are made by collecting quantitative data about the current state of the atmosphere at a given place and using meteorology to project how the atmosphere will change.

### SUMMARY

Aspects of the present invention disclose a method, computer program product, and system for generating test case requirements for testing an asset at a location using actual upcoming weather information. The method includes one or more processors receiving a set of usage parameters for an asset. The method further includes one or more processors a location from the received set of usage parameters. The method further includes one or more processors determining weather information that is associated with the identified location. The method further includes one or more processors generating a test case for the asset that includes one or more testing variables that test data in the determined weather information that is associated with the identified location.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program for generating test case requirements for testing an asset at a location using actual upcoming weather information, in accordance with embodiments of the present invention.

FIG. 3 is an example depiction of a test case set, which includes test cases generated by users and by testing program 200, in accordance with various embodiments of the present invention.

FIG. 4 depicts a block diagram of components of a computing system representative of the client devices and server of FIG. 1, in accordance with an embodiment of the present invention.

### DETAILED DESCRIPTION

Embodiments of the present invention provide a system and method to generate test case requirements for testing at a location using actual upcoming weather information (e.g., forecasts and predictions, etc.) corresponding to the specific location. Various embodiments of the present invention can operate to generate test cases for differing weather conditions, schedule testing at a location to march predicted weather and/or historical weather data, and identify potential additional test cases, based on the determined actual and forecast weather at a location.

Some embodiments of the present invention recognize that the creation, management, and execution of test cases are a very important aspect of asset development and product (i.e., asset) lifecycle management. However, embodiments of the present invention also recognize that an asset development and management system is limited by the knowledge that is made accessible to the system (e.g., the knowledge and creativity of the test engineers). If the test engineers do not have the foresight to create a test case dot a particular condition, then the condition will not be tested for. Accordingly, embodiments of the present invention recognize the advantages of providing the system with access to new data sources, such as weather information, to augment the generation and execution of test cases, and to populate new cases based on the data sources.

In addition, embodiments of the present invention can operate to receive a set of usage parameters of an asset (e.g., parameters of an asset under test from a test engineer). Embodiments of the present invention can then identify a location of the usage of the asset and determine weather information associated with the identified location. Further, embodiments of the present invention can then generate test cases for the asset based on the determined weather information and the populate a test case set corresponding to the asset with the generated test cases.

Implementation of embodiments of the invention may take a variety of forms, and exemplary implementation details are discussed subsequently with reference to the Figures.

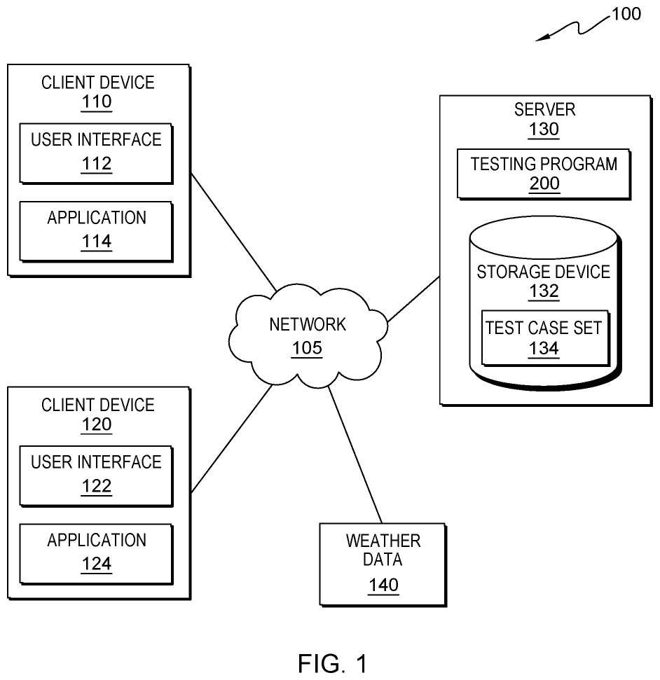

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

An embodiment of data processing environment 100 includes client device 110, client device 120, server 130, and weather data 140, all interconnected over network 105. In an example embodiment, server 130 is representative of a computing device (e.g., one or more management servers) that provides product lifecycle management (PLM) services to one or more organizations and users, such as users associated with client device 110 and client device 120. In other embodiments, data processing environment 100 can include additional instances of computing devices (not shown) that can interface with server 130, in accordance with various embodiments of the present invention.

Network 105 can be, for example, a local area network (LAN), a telecommunications network, a wide area network (WAN), such as the Internet, or any combination of the three, and include wired, wireless, or fiber optic connections. In general, network 105 can be any combination of connections and protocols that will support communications between client device 110, client device 120, server 130, and weather data 140, in accordance with embodiments of the present invention. In various embodiments, network 105 facilitates communication among a plurality of networked computing devices (e.g., client device 110, client device 120, server 130, and other devices not shown), corresponding users (e.g., users of client device 110, client device 120, and server 130, etc.), and corresponding management services (e.g., server 130 and weather data 140).

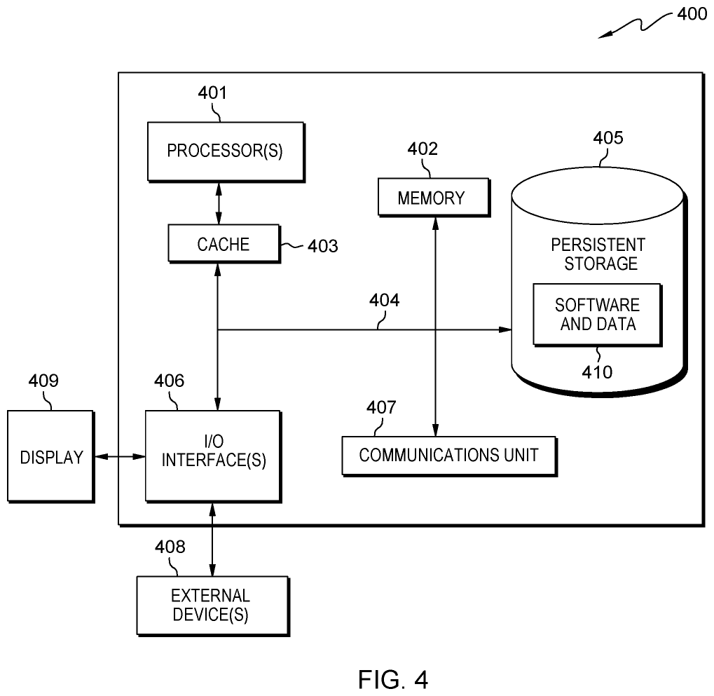

In various embodiments of the present invention, client device 110 and client device 120 may be a workstation, personal computer, personal digital assistant, mobile phone, or any other device capable of executing computer readable program instructions, in accordance with embodiments of the present invention. In general, client device 110 and client device 120 are representative of any electronic device or combination of electronic devices capable of executing computer readable program instructions. Client device 110 and client device 120 may include components as depicted and described in further detail with respect to FIG. 4, in accordance with embodiments of the present invention.

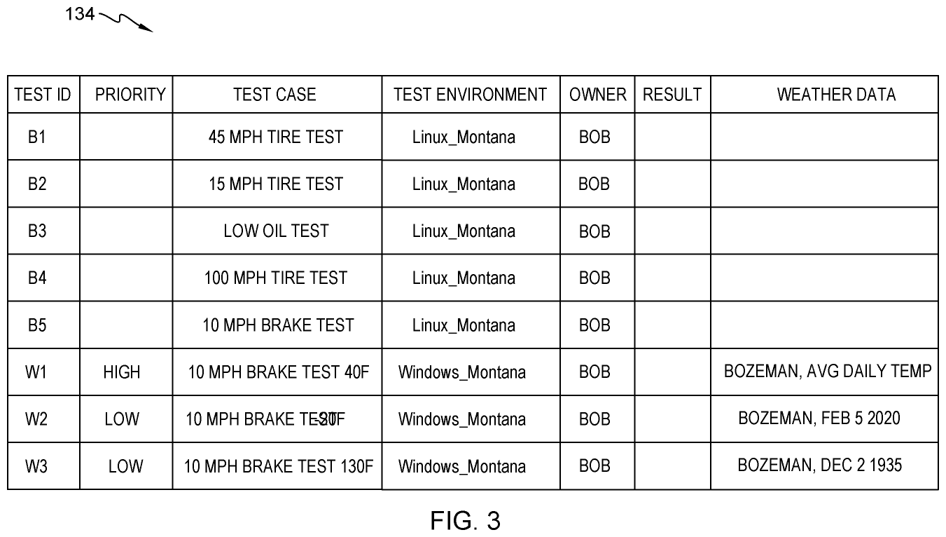

In an example embodiment, client device 110 is a personal workstation or mobile device associated with (e.g., registered to) a user that is providing information in the process of creating/generating test cases for an asset (e.g., an engineer creating test cases for an asset). In one example, client device 110 is associated with an engineer that is creating a test case set for testing an asset. In an example scenario, Bob is a reliability engineer and is creating a set of test cases for a new truck. In this example scenario, Bob utilizes client device 110 to create test case set 134, which is depicted in further detail with regard to FIG. 3. In this example scenario, Bob utilizes client device 110 to create test cases B1, B2, B3, B4, and B5 (indicated by the Test ID column).

In another example embodiment, client device 120 is a personal workstation or mobile device associated with (e.g., registered to) a user that is providing information in the process of inputting results of test cases for an asset (e.g., an engineer at the testing site, etc.). In an example scenario, the user of client device 120 can enter results of performed test cases in the “Result” column of test case set 134 of FIG. 3.

FIG. 3 is an example depiction of test case set 134, which includes test cases generated by users and by testing program 200, in accordance with various embodiments of the present invention. In the depicted example embodiment of test case set 134, the user of client device 110 (i.e., Bob) creates test cases B1, B2, B3, B4, and B5 (indicated by the Test ID column), and testing program 200 creates test cases W1, W2, and W3, in accordance with various embodiments of the present invention.

Client device 110 and client device 120 include respective instances of user interface 112, user interface 122, application 114, and application 124. User interface 112 and user interface 122 are programs that provides an interface between a respective user of client device 110 and client device 120, and a plurality of applications that reside on the device (e.g., application 114 and application 124). A user interface, such as user interface 112 or user interface 122, refers to the information (such as graphic, text, and sound) that a program presents to a user, and the control sequences the user employs to control the program. A variety of types of user interfaces exist. In one embodiment, user interface 112 and/or user interface 122 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 112 and/or user interface 122 is a script or application programming interface (API).

Application 114 and application 124 can be representative of one or more applications (e.g., an application suite) that operate on respective instances of client device 110 and client device 120. In various example embodiments, application 114 and application 124 can be an application that a user of client device 110 or client device 120 utilizes to send and/or receive data from server 130. For example, application 114 and application 124 can be a web browser that the user of client device 110 or client device 120 can access and utilize. In another example, application 114 and application 124 are enterprise-specific applications, associated with server 130 and/or the corresponding organization. In additional example embodiments, application 114 and application 124 can send data to, and receive data from, testing program 200 on server 130 (e.g., as a client-side application of testing program 200), in accordance with various embodiments of the present invention.

In example embodiments, server 130 can be a desktop computer, a computer server, or any other computer systems, known in the art. In certain embodiments, server 130 represents computer systems utilizing clustered computers and components (e.g., database server computers, application server computers, etc.) that act as a single pool of seamless resources when accessed by elements of data processing environment 100 (e.g., client device 110, client device 120, and other devices not shown). In general, server 130 is representative of any electronic device or combination of electronic devices capable of executing computer readable program instructions. Server 130 may include components as depicted and described in further detail with respect to FIG. 4, in accordance with embodiments of the present invention.

Server 130 includes testing program 200 and storage device 132, which includes test case set 134. In various embodiments of the present invention, server 130 operates as a computing system that provides product lifecycle management (PLM) services (for one or more assets) to one or more organizations and users, such as users associated with client device 110 and client device 120. In one embodiment, server 130 can host and store data associated with development and testing processes for one or more assets (e.g., in storage device 132). In additional embodiments, server 130 can access external data sources, such as weather data 140, to assist in providing PLM services (i.e., executing testing program 200), in accordance with various embodiments of the present invention.

In various embodiments of the present invention, the user of client device 110 (or client device 120) can register with server 130 (e.g., via a corresponding application). For example, the user completes a registration process, provides information, and authorizes the collection and analysis (i.e., opts-in) of relevant data provided by at least client device 110, by server 130 (e.g., user profile information, user contact information, authentication information, user preferences, or types of information, for server 130 utilize with testing program 200). In various embodiments, a user can opt-in or opt-out of certain categories of data collection. For example, the user can opt-in to provide all requested information, a subset of requested information, or no information. In additional embodiments, the user of client device 110 can define which information that server 130 can utilize in analyzing test case data (e.g., parameters, etc.) and in generating test cases, in accordance with embodiments of the present invention.

In example embodiments, testing program 200 generates test case requirements for testing an asset at a location using historical weather information and actual upcoming weather information, in accordance with embodiments of the present invention. In various embodiments, testing program 200 can identify a location of usage of an asset (based on provided usage parameters of the asset) and determine weather information associated with the identified location. For example, testing program 200 can access weather data 140 to gather weather data for the identified location. Further, testing program 200 can then generate test cases for the asset based on the determined weather information and the populate a test case set corresponding to the asset with the generated test cases.

In another embodiment, server 130 utilizes storage device 132 to store information associated with development and testing processes for one or more assets. For example, storage device 132 stores test case sets for a plurality of assets, such as test case set 134 (depicted in further detail in FIG. 3), which corresponds to a particular asset. Storage device 132 can store additional test cases and test case sets (not shown). In additional embodiments, storage device 132 can store historical test case data (e.g., completes test case sets, etc.), asset parameters and requirements, user preference data, known asset parameters, testing requirements, etc. Storage device 132 can be implemented with any type of storage device, for example, persistent storage 405, which is capable of storing data that may be accessed and utilized by server 130, such as a database server, a hard disk drive, or a flash memory. In other embodiments, storage device 132 can represent multiple storage devices and collections of data within server 130.

In various embodiments, test case set 134 is a set of test cases that correspond to a particular asset. In the previously discussed example scenario, Bob is a reliability engineer and is creating a set of test cases for a new truck (i.e., an asset). In this example scenario, Bob utilizes client device 110 to create test case set 134, which is depicted in further detail with regard to FIG. 3. In this example scenario, Bob utilizes client device 110 to create test cases B1, B2, B3, B4, and B5 (indicated by the Test ID column). In another aspect, the user of client device 120 can enter results of performed test cases in the “Result” column of test case set 134 of FIG. 3.

In additional embodiments, test case set 134 includes test cases that are generated/populated by users (e.g., users of client device 110 and client device 120) and through execution of testing program 200, in accordance with embodiments of the present invention. In the depicted example embodiment of test case set 134, the user of client device 110 (i.e., Bob) creates test cases B1, B2, B3, B4, and B5 (indicated by the Test ID column), and testing program 200 creates test cases W1, W2, and W3, in accordance with various embodiments of the present invention. For example, test case set 134 includes test cases B1, B2, B3, B4, and B5 prior to execution of testing program 200. Then, through execution, testing program 200 generates test cases W1, W2, and W3 in test case set 134. In other embodiments, storage device 132 can include additional sets of test cases and corresponding data (not shown).

Weather data 140 is representative of a weather service or other data resource that can provide historical weather data and weather forecast information in response to a request for a location. In one embodiment, weather data 140 can be a weather service (e.g., a weather application programming interface (API), or other application), that provides weather information and other meteorological values. In other embodiments, weather data 140 can be a database that includes weather information and other meteorological values, which a user can access and search for desired information (e.g., searched by the user of client device 110 and/or client device 120).

In example embodiments, weather data 140 can receive queries for weather information, and provides responses to the requesting entities (e.g., testing program 200, client device 110, etc.), in accordance with various embodiments of the present invention. For example, testing program 200 can send a request to weather data 140 for historical weather information for the location of Bozeman, Mont. Accordingly, in response to the request, weather data 140 can provide the requested historical information, including an average or median daily temperature, maximum temperature, minimum temperature, normal temperature values, historical weather conditions, forecast weather conditions, etc. In various aspects, the weather information can include temperature, humidity, atmospheric pressure, wind, precipitation, etc.

In another embodiment, weather data 140 can be representative of a data repository that includes actual weather data gathered from assets that are currently in operation. For example, weather data 140 can include indications of where existing asserts are sold and in operation. In this example, the information can then feed into server 130 to provide relevant information on where similar assets are currently in operation, thus providing accurate operational information for the asset under test.

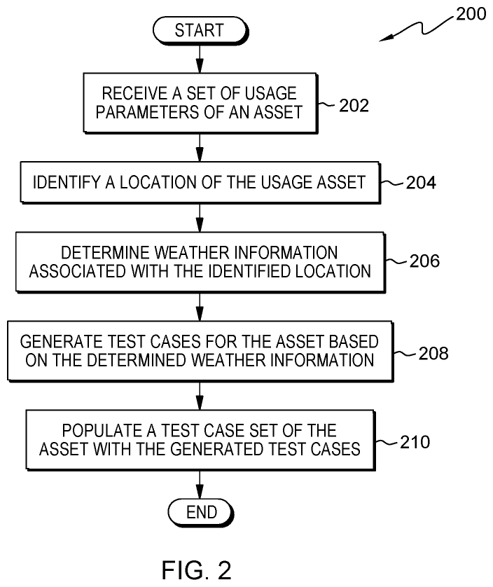

FIG. 2 is a flowchart depicting operational steps of testing program 200, a program for generating test case requirements for testing am asset at a location using actual upcoming weather information, in accordance with embodiments of the present invention. In one embodiment, testing program 200 initiates in response to a user request (e.g., a request to initiate from the user of client device 110). In another embodiment, testing program 200 can operate as a background process during test case creation and management, in accordance with various aspects of the present invention. In additional embodiments, server 130 utilizes testing program 200 to augment the existing test case generation and management processes that server 130 facilitates.

In step 202, testing program 200 receives a set of usage parameters of an asset. In one embodiment, testing program 200 receives a set of usage parameters of an asset under test, input by a user associated with testing the asset, such as a testing engineer that utilizes client device 110. In an example embodiment, the asset is an asset under test that corresponds to test case set 134. For example, an asset can be product or service that can undergo testing (e.g., with an engineering lifecycle management system for requirements management and test management). In an example with regard to FIG. 3, the asset is a new truck that is undergoing testing.

In various embodiments, testing program 200 can receive a variety of different parameters, which provide information that relates to the operational conditions of the asset. For example, the testing engineer utilizing client device 110 provides usage parameters that indicate whether the asset will operate indoors or outdoors. In additional examples, for assets that can operate outdoors, the usage parameters can include indications of climates and locations for operating the asset (and corresponding dates and times of year). In an example scenario, as depicted in test case set 134 in FIG. 3, testing engineer Bob (using client device 110) provides usage parameters that indicate the asset (i.e., the truck being tested) will operate outdoors. In addition, Bob also provides usage parameters that indicate operation of the asset in Bozeman, Mont.

In step 204, testing program 200 identifies a location of the usage of the asset. In one embodiment, testing program 200 identifies an intended usage and/or a testing location for the asset, from the received set of usage parameters (provided in step 202). In the previously discussed example scenario, testing program 200 parses the parameters provided by Bob and identifies the location of Bozeman, Mont. In an additional example, testing program 200 can identify that the parameters indicate outdoor usage of the asset in Bozeman, Mont.

In another embodiment, if testing program 200 determines that the received parameters (received in step 202) do not include an indication of a usage location, then testing program can send a query to request input of a usage location for the asset. For example, testing program 200 sends a query to a user associated with testing the asset, such as a testing engineer associated with client device 110 or client device 120.

In step 206, testing program 200 determines weather information associated with the identified location. In one embodiment, testing program 200 queries weather data 140 for weather information based on the identified location of usage of the asset (from step 204). In example embodiments, the determined weather information includes historical weather data for a location. In various embodiments, testing program 200 can query weather data 140 for historical weather information corresponding to the identified location of usage of the asset, based on the usage parameters (e.g., location, date, time, climate, etc.). In another embodiment, testing program 200 can also determine and/or request weather information that includes a weather forecast for the identified location of the usage of the asset.

In example embodiments, testing program 200 can query a weather service (e.g., weather data 140) for meteorological variables for predicted operation locations of the asset, such as the identified location from the parameters. For example, the meteorological variables can include temperature, humidity, atmospheric pressure, wind, precipitation, etc. In additional aspects, testing program 200 can also determine additional location data for the identified location of usage, such as coordinates (longitude and latitude), terrain, altitude, nearby bodies of water, currents/conditions of the nearby bodies of water, etc. In another embodiment, testing program 200 can analyze historical weather data for a location to determine historical meteorological variables, including temperature ranges, humidity ranges, atmospheric pressure ranges, wind ranges, precipitation ranges, etc.

In the previously discussed example scenario, testing program 200 parsed the parameters provided by Bob to identify the location of Bozeman, Mont. (in step 204). Accordingly, testing program 200 can then determine weather information for Bozeman, Mont. by querying weather data 140 for historical weather data of Bozeman, Mont.

In step 208, testing program 200 generates test cases for the asset based on the determined weather information. In one embodiment, testing program 200 generates one or more test cases (e.g., test case shells) for a test case set of the asset, which take into account the determined weather information (from step 206) for the identified usage location for the asset. In an example embodiment, testing program 200 generates a new ELM test case shell for one or more combinations of potential weather information and meteorological data for the location (from step 206). For example, testing program 200 generates test case shells to test weather extremes (e.g., maximum and minimum values) from the weather information for the usage location. In additional examples, testing program 200 can generate test case shells to include testing variables that test the data characteristics from the weather information (e.g., normal/expected values, forecast values, median/average values outliers, etc.). A test case shell is a partially populated test case (e.g., for an ELM system).

In additional embodiments, testing program 200 tags generated test shells with corresponding information about the location and/or climate, and a corresponding rationale for generating the test case (e.g., average daily temperature at a location, maximum recorded temperature at a location, etc.). In another embodiment, testing program 200 can tag a generated test case shell with an indication of priority for the test case. For example, a low priority can indicate a rare or uncommon weather combination (e.g., weather extremes). In another example, a high priority can indicate weather patterns that are common throughout the entire year and/or weather patterns that are common in different operating locations (e.g., northern and southern hemisphere conditions, etc.). In an additional example, a medium priority can indicate weather patterns that occur during different seasons. Testing program 200 can further utilize any defines set of priorities when tagging test cases, in accordance with embodiments of the present invention.

In various embodiments, testing program 200 can analyze the historical weather information for a location to identify variables to utilize when generating testing variables for test cases for the asset, such as a minimum temperature, a maximum temperature, a minimum humidity, a maximum humidity, a minimum atmospheric pressure, a maximum atmospheric pressure, a minimum wind speed, a maximum wind speed, and a minimum precipitation and a maximum precipitation. In another embodiment, testing program 200 (and server 130) can receive weather predictions for a location and create additional test cases (and testing variables) based on an assessment of differences of the weather predictions compared to historical meteorological variables and predicted meteorological variables for the location.

In a further embodiment, testing program 200 can analyze an existing set of test cases (e.g., test case set 134) to identify testing variables and parameters that are missing from the set of test cases (i.e., gaps in testing). Accordingly, testing program 200 can then generate test cases to fill in the identified gaps in testing. For example, testing program 200 can identify weather conditions that are indicated as desired and/or required test conditions for an asset that are missing from a test case set. In this example, testing program 200 can generate test cases to that fill in the missing test cases, based on weather information that is relevant to the asset under test (i.e., based on the location).

In the previously discussed example scenario, Bob is a reliability engineer and is creating a set of test cases for a new truck. In this example scenario, Bob utilizes client device 110 to create test case set 134, which is depicted in further detail with regard to FIG. 3. In this example scenario, Bob utilizes client device 110 to create test cases B1, B2, B3, B4, and B5 (indicated by the Test ID column). Bob can then select to generate test cases based on weather of one or more locations. Accordingly, Bob initiates operation of testing program 200 and provides a set of usage parameters for the truck (i.e., the asset) (step 202). In this example scenario, the usage parameters include the location of Bozeman, Mont., and an indication of outside usage.

Further, in this example scenario, testing program 200 identifies the usage location of Bozeman, Mont. (step 204) and then determines weather information for Bozeman, Mont. (step 206). In various embodiments, testing program 200 can communicate with weather data 140 to determine weather information that includes climate information and determine typical weather conditions for different times of the year for Bozeman, Mont. Accordingly, testing program 200 generates one or more test case shells (e.g., test case templates) that assist Bob in capturing relevant weather variables during testing. For example, testing program 200 can operate to generate test cases that test combinations of weather conditions that Bob had not previously considered (e.g., weather extremes from historical weather data, etc.).

In this example scenario, testing program 200 generates test cases W1, W2, and W3 in test case set 134 (in step 208), depicted in FIG. 3. As depicted in FIG. 2, testing program 200 generates test case W1, which is a high priority test case to perform a 10 mile per hour (mph) brake test at 40 degrees Fahrenheit that represents the average daily temperature in Bozeman, Mont. Further, testing program 200 generates test case W2, which is a low priority test case to perform a 10 (mph) brake test at −20 degrees Fahrenheit, and testing program 200 generates test case W3, which is a low priority test case to perform a 10 (mph) brake test at 130 degrees Fahrenheit. The low priority test cases correspond to historical maximum and minimum temperature data from the weather information of Bozeman, Mont. In the depicted example embodiment of FIG. 3, testing program 200 assigns a high priority to test case W1 because test case W1 is directed to normal weather conditions, whereas the extreme conditions of test cases W2 and W3 can correspond to a lower priority. In various embodiments, testing program 200 can assign priority to test cases based on any relevant preference metric.

In step 210, testing program 200 populates a test case set of the asset with the generated test cases. In one embodiment, testing program 200 adds the generated test case(s) (in step 208) to the test case set for the asset under test (e.g., test case set 134). In example embodiments, testing program 200 can provide a rationale that indicates why a test case was generated and added to a test case set. For example, a date and/or location when the corresponding weather pattern was observed, a data and/or location where the corresponding weather pattern is forecast to occur in the future, etc.

In the previously discussed example scenario, testing program 200 adds test cases W1, W2, and W3 (generated in step 208) to test case set 134, as depicted in FIG. 3. In addition, testing program 200 can populate the “Weather Data” column of test case set 134 with the evidence (i.e., piece of weather information) that explains why testing program 200 generated the test case and adds the test case to test case set 134. Accordingly, testing program 200 can add test cases W1, W2, and W3 to test case set 134, as depicted in FIG. 3, in accordance with various embodiments of the present invention.

In further embodiments, a user of client device 110 and/or client device 120 can populate the test case shells generated by testing program 200 with any missing and/or requested information. For example, a user of client device 120 can input test results into test case set 134, in response to completion of a corresponding test. In another example, the user of client device 110 (e.g., testing engineer) can modify parameters, priority, etc., of the generated test cases.

FIG. 3 is an example depiction of test case set 134, which includes test cases generated by users and by testing program 200, in accordance with various embodiments of the present invention. In the depicted example embodiment of test case set 134, the user of client device 110 (i.e., Bob) creates test cases B1, B2, B3, B4, and B5 (indicated by the Test ID column), and testing program 200 creates test cases W1, W2, and W3, in accordance with various embodiments of the present invention.

The depicted example of test case set 134 in FIG. 3 includes columns that correspond to respective test cases (indicated by Test ID) and columns that include information and parameters/variables of the respective test cases (i.e., Test ID, Priority, Test Case, Test Environment, Owner, Result, and Weather data). Alternative examples of a test case set can include different row and column configurations, based on the asset under test. Example processes and embodiments for crating and populating test case set 134 are previously discussed in further detail with regard to FIG. 2.

FIG. 4 depicts computer system 400, which is representative of client device 110, client device 120, and server 130, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made. Computer system 400 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data (e.g., software and data 410) used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Software and data 410 can be stored in persistent storage 405 for access and/or execution by one or more of the respective processor(s) 401 via cache 403. With respect to client device 110, software and data 410 includes user interface 112 and application 114. With respect to client device 120, software and data 410 includes user interface 122 and application 124. With respect to server 130, software and data 410 includes testing program 200 and test case set 134.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data (e.g., software and data 410) used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Program instructions and data (e.g., software and data 410) used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
receiving, by one or more processors, a set of usage parameters for an asset;
identifying, by one or more processors, a location from the received set of usage parameters;
determining, by one or more processors, weather information that is associated with the identified location; and
generating, by one or more processors, a test case for the asset that includes one or more testing variables that test data in the determined weather information that is associated with the identified location.

2. The method of claim 1, further comprising:
adding, by one or more processors, the generated test case to an existing test case set that corresponds to the asset.

3. The method of claim 1, wherein determining weather information that is associated with the identified location further comprises:
querying, by one or more processors, a weather service for weather information that corresponds to the identified location, the weather information including historical weather data and forecast weather data.

4. The method of claim 3, wherein the historical weather data includes maximum, minimum, and averages of meteorological variables selected from the group consisting of:
temperature, humidity, precipitation, wind, and atmospheric pressure.

5. The method of claim 1, wherein generating the test case for the asset that includes one or more testing variables that test data in the determined weather information that is associated with the identified location, further comprising:
generating, by one or more processors, a test case shell that includes a testing variable to test an average temperature at the identified location, wherein the average temperature is derived from the determined weather information.

6. The method of claim 1, wherein the received set of usage parameters include an input location, an indication of indoor or outdoor usage, and a request to generate test cases for the input location.

7. The method of claim 2, further comprising:
populating, by one or more processors, the generated test case with an indication of a reasoning for including the one or more testing variables in the test case.

8. A computer program product comprising:
one or more computer readable storage media and program instructions stored on the one or more computer readable storage media, the program instructions comprising:
program instructions to receive a set of usage parameters for an asset;
program instructions to identify a location from the received set of usage parameters;
program instructions to determine weather information that is associated with the identified location; and
program instructions to generate a test case for the asset that includes one or more testing variables that test data in the determined weather information that is associated with the identified location.

9. The computer program product of claim 8, further comprising program instructions, stored on the one or more computer readable storage media, to:
add the generated test case to an existing test case set that corresponds to the asset.

10. The computer program product of claim 8, wherein the program instructions to determine weather information that is associated with the identified location further comprise program instructions to:
query a weather service for weather information that corresponds to the identified location, the weather information including historical weather data and forecast weather data.

11. The computer program product of claim 10, wherein the historical weather data includes maximum, minimum, and averages of meteorological variables selected from the group consisting of: temperature, humidity, precipitation, wind, and atmospheric pressure.

12. The computer program product of claim 8, wherein the program instructions to generate the test case for the asset that includes one or more testing variables that test data in the determined weather information that is associated with the identified location further comprise program instructions to:
generate a test case shell that includes a testing variable to test an average temperature at the identified location, wherein the average temperature is derived from the determined weather information.

13. The computer program product of claim 8, wherein the received set of usage parameters include an input location, an indication of indoor or outdoor usage, and a request to generate test cases for the input location.

14. A computer system comprising:
one or more computer processors;
one or more computer readable storage media; and
program instructions stored on the computer readable storage media for execution by at least one of the one or more processors, the program instructions comprising:
program instructions to receive a set of usage parameters for an asset;
program instructions to identify a location from the received set of usage parameters;
program instructions to determine weather information that is associated with the identified location; and
program instructions to generate a test case for the asset that includes one or more testing variables that test data in the determined weather information that is associated with the identified location.

15. The computer system of claim 14, further comprising program instructions, stored on the computer readable storage media for execution by at least one of the one or more processors, to:
add the generated test case to an existing test case set that corresponds to the asset.

16. The computer system of claim 14, wherein the program instructions to determine weather information that is associated with the identified location further comprise program instructions to:
query a weather service for weather information that corresponds to the identified location, the weather information including historical weather data and forecast weather data.

17. The computer system of claim 16, wherein the historical weather data includes maximum, minimum, and averages of meteorological variables selected from the group consisting of: temperature, humidity, precipitation, wind, and atmospheric pressure.

18. The computer system of claim 14, wherein the program instructions to generate the test case for the asset that includes one or more testing variables that test data in the determined weather information that is associated with the identified location further comprise program instructions to:
generate a test case shell that includes a testing variable to test an average temperature at the identified location, wherein the average temperature is derived from the determined weather information.

19. The computer system of claim 14, wherein the received set of usage parameters include an input location, an indication of indoor or outdoor usage, and a request to generate test cases for the input location.

20. The computer system of claim 15, further comprising program instructions, stored on the computer readable storage media for execution by at least one of the one or more processors, to:
populate the generated test case with an indication of a reasoning for including the one or more testing variables in the test case.
